(19) United States
(12) Patent Application Publication
(10) Pub. No.: US 2025/0330926 A1
(43) Pub. Date: Oct. 23, 2025

(54) ACCESS POINT SYNCHRONIZATION

(71) Applicant: QUALCOMM Incorporated, San Diego, CA (US)

(72) Inventors: Nicolas GRAUBE, Cambridge (GB); Zhaoming YANG, Shanghai (CN); Liuliu ZHAO, Shanghai (CN); Zaiyong CHEN, Shanghai (CN); Weidong YANG, Shanghai (CN); Tingting LIU, Cambridge (GB); Abhishek PRASAD, Barrington (GB)

(21) Appl. No.: 18/868,955

(22) PCT Filed: Aug. 1, 2022
(86) PCT No.: PCT/CN2022/109418

§ 371 Date: Nov. 25, 2024

(51) Int. Cl. H04W 56/00; H04B 17/318; H04L 5/00; H04W 24/08

(52) U.S. Cl. CPC H04W 56/0015; H04B 17/328; H04L 5/0012; H04W 24/08

(57) ABSTRACT

In some aspects, an access point (AP) may detect a periodic advertisement broadcast from another AP. The AP may transmit, to the other AP, a message to initiate a connection between the other AP and the AP. The AP may receive, from the other AP, a synchronization message that identifies at least one of a periodic advertisement timing used by the other AP or a set of index values that includes at least a first index value associated with the other AP, the first index value indicating a first hopping frequency sequence (HFS) used by the other AP. The AP may transmit periodic advertisements synchronized with the periodic advertisement timing used by the other AP and according to a second HFS that is based at least in part on a second index value associated with the AP, the second HFS being orthogonal to the first HFS. Numerous other aspects are described.

### FIELD OF THE DISCLOSURE

Aspects of the present disclosure generally relate to wireless communication and, for example, to access point synchronization.

### BACKGROUND

Short range wireless communication enables wireless communication over relatively short distances (e.g., within 30 meters). For example, BLUETOOTH® is a wireless technology standard for exchanging data over short distances using short-wavelength ultra high frequency (UHF) radio waves from 2.4 gigahertz (GHz) to 2.485 GHz. BLUETOOTH® Low Energy (BLE) is a form of BLUETOOTH® communication that allows for communication with devices running on low power. Such devices may include beacons, which are wireless communication devices that may use low-energy communication technology for locationing, proximity marketing, or other purposes. Furthermore, such devices may serve as nodes (e.g., relay nodes) of a wireless mesh network that communicates and/or relays information to a managing platform or hub associated with the wireless mesh network.

### SUMMARY

Some aspects described herein relate to a method performed by an access point. The method may include detecting a periodic advertisement broadcast from another access point. The method may include transmitting, to the other access point and based on detecting the periodic advertisement, a message to initiate a connection between the other access point and the access point. The method may include receiving, from the other access point, a synchronization message that identifies at least one of a periodic advertisement timing used by the other access point or a set of index values that includes at least a first index value associated with the other access point, the first index value indicating a first hopping frequency sequence used by the other access point. The method may include transmitting periodic advertisements synchronized with the periodic advertisement timing used by the other access point and according to a second hopping frequency sequence that is based at least in part on a second index value associated with the access point, the second hopping frequency sequence being orthogonal to the first hopping frequency sequence.

Some aspects described herein relate to a method performed by an access point. The method may include transmitting periodic advertisements. The method may include receiving, from another access point that detected one or more of the periodic advertisements, a message to initiate a connection between the access point and the other access point. The method may include transmitting, to the other access point, a synchronization message that identifies at least one of a periodic advertisement timing used by the access point or a set of index values that includes at least an index value associated with the access point, the index value indicating a hopping frequency sequence used by the access point.

Some aspects described herein relate to a method performed by a management entity. The method may include receiving, from a plurality of access points, respective messages indicating detection of a periodic advertisement from an access point, the plurality of access points associated with respective index values indicating hopping frequency sequences used by the plurality of access points. The method may include determining, for the access point, a leader access point, from among the plurality of access points, and an index value indicating a hopping frequency sequence, the hopping frequency sequence being orthogonal to each of the hopping frequency sequences used by the plurality of access points. The method may include transmitting, to the leader access point, information that identifies the access point and the index value.

Some aspects described herein relate to a method performed by a wireless communication device. The method may include receiving information identifying a set of index values respectively associated with a plurality of access points, the set of index values indicating hopping frequency sequences used by the plurality of access points. The method may include detecting that synchronization between the wireless communication device and an access point, of the plurality of access points, has been lost. The method may include monitoring for periodic advertisements, broadcast from at least one additional access point of the plurality of access points, according to the hopping frequency sequences indicated by the set of index values. The method may include detecting a periodic advertisement broadcast from an additional access point, of the plurality of access points, based at least in part on monitoring for periodic advertisements.

Some aspects described herein relate to an access point. The access point may include a memory and one or more processors coupled to the memory. The one or more processors may be configured to detect a periodic advertisement broadcast from another access point. The one or more processors may be configured to transmit, to the other access point and based on detecting the periodic advertisement, a message to initiate a connection between the other access point and the access point. The one or more processors may be configured to receive, from the other access point, a synchronization message that identifies at least one of a periodic advertisement timing used by the other access point or a set of index values that includes at least a first index value associated with the other access point, the first index value indicating a first hopping frequency sequence used by the other access point. The one or more processors may be configured to transmit periodic advertisements synchronized with the periodic advertisement timing used by the other access point and according to a second hopping frequency sequence that is based at least in part on a second index value associated with the access point, the second hopping frequency sequence being orthogonal to the first hopping frequency sequence.

Some aspects described herein relate to an access point. The access point may include a memory and one or more processors coupled to the memory. The one or more processors may be configured to transmit periodic advertisements. The one or more processors may be configured to receive, from another access point that detected one or more of the periodic advertisements, a message to initiate a connection between the access point and the other access point. The one or more processors may be configured to transmit, to the other access point, a synchronization message that identifies at least one of a periodic advertisement timing used by the access point or a set of index values that includes at least an index value associated with the access point, the index value indicating a hopping frequency sequence used by the access point.

Some aspects described herein relate to a management entity. The management entity may include a memory and one or more processors coupled to the memory. The one or more processors may be configured to receive, from a plurality of access points, respective messages indicating detection of a periodic advertisement from an access point. The one or more processors may be configured to determine, for the access point, a leader access point, from among the plurality of access points, and an index value indicating a hopping frequency sequence. The one or more processors may be configured to transmit, to the leader access point, information that identifies the access point and the index value.

Some aspects described herein relate to a wireless communication device. The wireless communication device may include a memory and one or more processors coupled to the memory. The one or more processors may be configured to receive information identifying a set of index values respectively associated with a plurality of access points, the set of index values indicating hopping frequency sequences used by the plurality of access points. The one or more processors may be configured to detect that synchronization between the wireless communication device and an access point, of the plurality of access points, has been lost. The one or more processors may be configured to monitor for periodic advertisements, broadcast from at least one additional access point of the plurality of access points, according to the hopping frequency sequences indicated by the set of index values. The one or more processors may be configured to detect a periodic advertisement broadcast from an additional access point, of the plurality of access points, based at least in part on monitoring for periodic advertisements.

Some aspects described herein relate to a non-transitory computer-readable medium that stores a set of instructions for an access point. The instructions, when executed by one or more processors of the access point, may cause the access point to detect a periodic advertisement broadcast from another access point. The instructions, when executed by one or more processors of the access point, may cause the access point to transmit, to the other access point and based on detecting the periodic advertisement, a message to initiate a connection between the other access point and the access point. The instructions, when executed by one or more processors of the access point, may cause the access point to receive, from the other access point, a synchronization message that identifies at least one of a periodic advertisement timing used by the other access point or a set of index values that includes at least a first index value associated with the other access point, the first index value indicating a first hopping frequency sequence used by the other access point. The instructions, when executed by one or more processors of the access point, may cause the access point to transmit periodic advertisements synchronized with the periodic advertisement timing used by the other access point and according to a second hopping frequency sequence that is based at least in part on a second index value associated with the access point, the second hopping frequency sequence being orthogonal to the first hopping frequency sequence.

Some aspects described herein relate to a non-transitory computer-readable medium that stores a set of instructions for an access point. The set of instructions, when executed by one or more processors of the access point, may cause the access point to transmit periodic advertisements. The set of instructions, when executed by one or more processors of the access point, may cause the access point to receive, from another access point that detected one or more of the periodic advertisements, a message to initiate a connection between the access point and the other access point. The set of instructions, when executed by one or more processors of the access point, may cause the access point to transmit, to the other access point, a synchronization message that identifies at least one of a periodic advertisement timing used by the access point or a set of index values that includes at least an index value associated with the access point, the index value indicating a hopping frequency sequence used by the access point.

Some aspects described herein relate to a non-transitory computer-readable medium that stores a set of instructions for a management entity. The set of instructions, when executed by one or more processors of the management entity, may cause the management entity to receive, from a plurality of access points, respective messages indicating detection of a periodic advertisement from an access point. The set of instructions, when executed by one or more processors of the management entity, may cause the management entity to determine, for the access point, a leader access point, from among the plurality of access points, and an index value indicating a hopping frequency sequence. The set of instructions, when executed by one or more processors of the management entity, may cause the management entity to transmit, to the leader access point, information that identifies the access point and the index value.

Some aspects described herein relate to a non-transitory computer-readable medium that stores a set of instructions for a wireless communication device. The set of instructions, when executed by one or more processors of the wireless communication device, may cause the wireless communication device to receive information identifying a set of index values respectively associated with a plurality of access points, the set of index values indicating hopping frequency sequences used by the plurality of access points. The set of instructions, when executed by one or more processors of the wireless communication device, may cause the wireless communication device to detect that synchronization between the wireless communication device and an access point, of the plurality of access points, has been lost. The set of instructions, when executed by one or more processors of the wireless communication device, may cause the wireless communication device to monitor for periodic advertisements, broadcast from at least one additional access point of the plurality of access points, according to the hopping frequency sequences indicated by the set of index values. The set of instructions, when executed by one or more processors of the wireless communication device, may cause the wireless communication device to detect a periodic advertisement broadcast from an additional access point, of the plurality of access points, based at least in part on monitoring for periodic advertisements.

Some aspects described herein relate to an apparatus. The apparatus may include means for detecting a periodic advertisement broadcast from an access point. The apparatus may include means for transmitting, to the access point and based on detecting the periodic advertisement, a message to initiate a connection between the access point and the apparatus. The apparatus may include means for receiving, from the access point, a synchronization message that identifies at least one of a periodic advertisement timing used by the access point or a set of index values that includes at least a first index value associated with the access point, the first index value indicating a first hopping frequency sequence used by the access point. The apparatus may include means for transmitting periodic advertisements synchronized with the periodic advertisement timing used by the access point and according to a second hopping frequency sequence that is based at least in part on a second index value associated with the apparatus, the second hopping frequency sequence being orthogonal to the first hopping frequency sequence.

Some aspects described herein relate to an apparatus. The apparatus may include means for transmitting periodic advertisements. The apparatus may include means for receiving, from an access point that detected one or more of the periodic advertisements, a message to initiate a connection between the apparatus and the access point. The apparatus may include means for transmitting, to the access point, a synchronization message that identifies at least one of a periodic advertisement timing used by the apparatus or a set of index values that includes at least an index value associated with the apparatus, the index value indicating a hopping frequency sequence used by the apparatus.

Some aspects described herein relate to an apparatus. The apparatus may include means for receiving, from a plurality of access points, respective messages indicating detection of a periodic advertisement from an access point, the plurality of access points associated with respective index values indicating hopping frequency sequences used by the plurality of access points. The apparatus may include means for determining, for the access point, a leader access point, from among the plurality of access points, and an index value indicating a hopping frequency sequence, the hopping frequency sequence being orthogonal to each of the hopping frequency sequences used by the plurality of access points. The apparatus may include means for transmitting, to the leader access point, information that identifies the access point and the index value.

Some aspects described herein relate to an apparatus. The apparatus may include means for receiving information identifying a set of index values respectively associated with a plurality of access points, the set of index values indicating hopping frequency sequences used by the plurality of access points. The apparatus may include means for detecting that synchronization between the apparatus and an access point, of the plurality of access points, has been lost. The apparatus may include means for monitoring for periodic advertisements, broadcast from at least one additional access point of the plurality of access points, according to the hopping frequency sequences indicated by the set of index values. The apparatus may include means for detecting a periodic advertisement broadcast from an additional access point, of the plurality of access points, based at least in part on monitoring for periodic advertisements.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of a device, in accordance with the present disclosure.

FIG. 3A is a diagram illustrating an example associated with discovery and synchronization between access points, in accordance with the present disclosure.

FIG. 3B is a diagram illustrating an example associated with discovery and synchronization between access points, in accordance with the present disclosure.

FIG. 4 is a diagram illustrating an example associated with handover of a wireless communication device, in accordance with the present disclosure.

FIG. 5 is a flowchart of an example process associated with access point synchronization, in accordance with the present disclosure.

FIG. 6 is a flowchart of an example process associated with access point synchronization, in accordance with the present disclosure.

FIG. 7 is a flowchart of an example process associated with access point synchronization, in accordance with the present disclosure.

FIG. 8 is a flowchart of an example process associated with handover of a wireless communication device, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

An electronic shelf label (ESL) system may include one or more ESLs that are controlled by a management entity. To facilitate control by the management entity, each ESL may have a wireless connection (e.g., a BLUETOOTH® Low Energy (BLE) connection) to an access point that is communicatively connected to the management entity (e.g., via the Internet). Thus, commands from the management entity may be wirelessly transmitted to the ESL by the access point.

In some cases, an ESL may be physically moved to a new location. For example, the ESL may be moved from one location in a store (e.g., a particular shelf or a storage area) to a different location. Changing the location of the ESL may result in the ESL losing synchronization with a current access point for the ESL (e.g., due to being out of range), thereby interrupting the management entity's ability to control the ESL and the ESL's ability to report to the management entity. After determining a network outage (e.g., caused by the loss of synchronization), the ESL may perform an onboarding procedure to reestablish synchronization with an access point. To perform the onboarding procedure, the ESL may transmit advertisement messages, receive a connection request from an in-range access point that detected the advertisement messages, and exchange messages with the access point (e.g., including the exchange of periodic advertisement synchronization transfer (PAST) information). The onboarding procedure may consume significant computing resources (e.g., processor resources, memory resources, and/or battery resources, among other examples) of the ESL and/or the access point, and frequent advertisement by one or more ESLs may result in spectral pollution on advertisement channels of the wireless network.

Some techniques and apparatuses described herein enable discovery and synchronization of communication timings of multiple access points in an ESL system. In particular, periodic advertisement timings used by the multiple access points may be synchronized. The multiple access points may use respective, orthogonal hopping frequency sequences (HFSs) to avoid interference among the multiple access points. In some aspects, the HFS used by an access point may be based on an index value (e.g., that indicates a shift relative to a reference HFS), and the ESLs in the ESL system may receive information indicating the respective index values for the multiple access points.

In this way, if an ESL loses synchronization with an access point, then the ESL may search for periodic advertisements of other access points based on the synchronized periodic advertisement timing and on channels indicated by (e.g., derived from) the index values for the multiple access points. In other words, due to the periodic advertisement timings of the multiple access points being synchronized, the time synchronization that the ESL has with the ESL's current access point is also applicable to other access points. Accordingly, the ESL may efficiently detect periodic advertisements of, and establish synchronization with, another access point without performing the full onboarding procedure described above. Moreover, rather than monitoring all channels for periodic advertisements, the ESL may monitor for periodic advertisements only in channels according to the HFSs indicated by the index values. Thus, the techniques described herein conserve radio resources or computing resources (e.g., processor resources, memory resources, and/or battery resources, among other examples) of the ESL and/or the access point, and reduce spectral pollution on the advertisement channels.

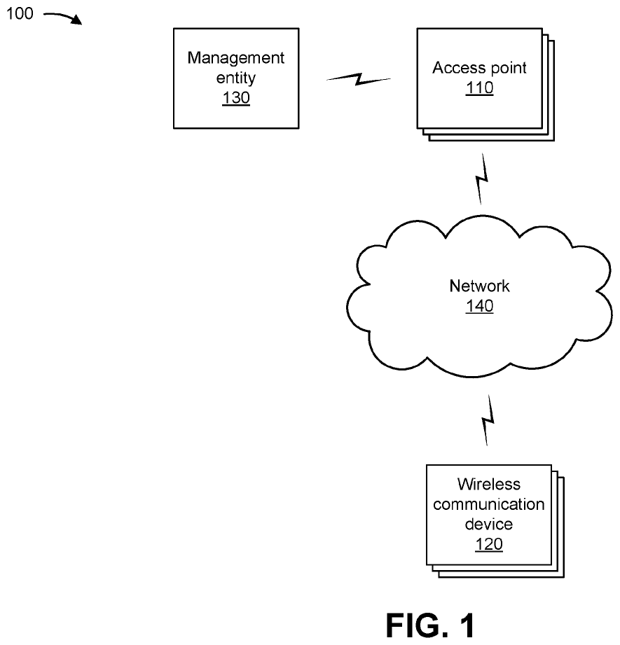

FIG. 1 is a diagram of an example environment 100 in which systems and/or methods described herein may be implemented. As shown in FIG. 1, environment 100 may include at least one access point 110, at least one wireless communication device 120, a management entity 130, and a network 140. Devices of environment 100 may interconnect via wired connections, wireless connections, or a combination of wired and wireless connections.

The access point 110 may include one or more devices capable receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an ESL.

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

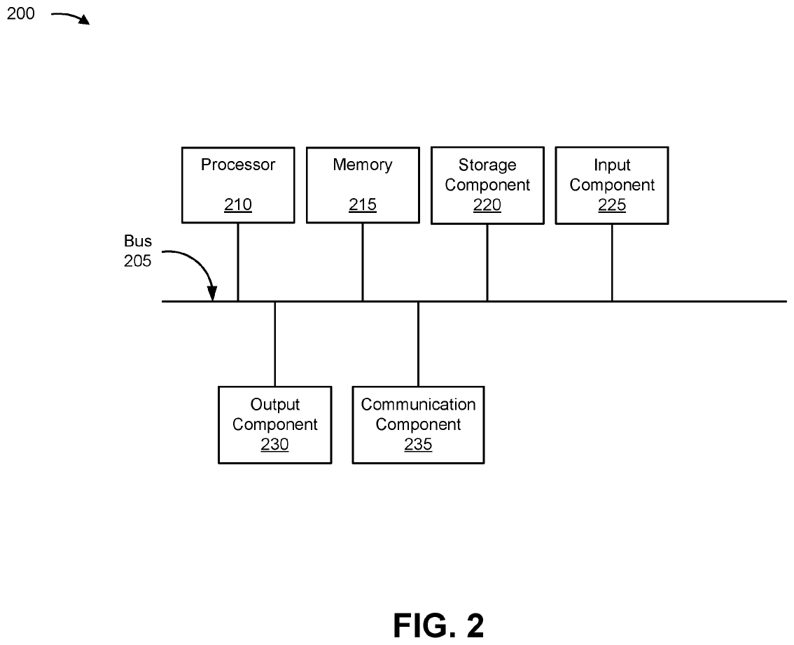

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication component 235 includes a transceiver-like component (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. In some aspects, device 200 includes means for detecting a periodic advertisement broadcast from an access point; means for transmitting, to the access point and based on detecting the periodic advertisement, a message to initiate a connection between the access point and device 200; means for receiving, from the access point, a synchronization message that identifies at least one of a periodic advertisement timing used by the access point or a set of index values that includes at least a first index value associated with the access point, the first index value indicating a first hopping frequency sequence used by the access point; means for transmitting periodic advertisements synchronized with the periodic advertisement timing used by the access point and according to a second hopping frequency sequence that is based at least in part on a second index value associated with device 200, the second hopping frequency sequence being orthogonal to the first hopping frequency sequence; or the like. In some aspects, device 200 includes means for transmitting periodic advertisements; means for receiving, from an access point that detected one or more of the periodic advertisements, a message to initiate a connection between device 200 and the access point; means for transmitting, to the access point, a synchronization message that identifies at least one of a periodic advertisement timing used by device 200 or a set of index values that includes at least an index value associated with device 200, the index value indicating a hopping frequency sequence used by device 200; or the like. In some aspects, device 200 includes means for receiving, from a plurality of access points, respective messages indicating detection of a periodic advertisement from an access point, the plurality of access points associated with respective index values indicating hopping frequency sequences used by the plurality of access points; means for determining, for the access point, a leader access point, from among the plurality of access points, and an index value indicating a hopping frequency sequence, the hopping frequency sequence being orthogonal to each of the hopping frequency sequences used by the plurality of access points; means for transmitting, to the leader access point, information that identifies the access point and the index value; or the like. In some aspects, device 200 includes means for receiving information identifying a set of index values respectively associated with a plurality of access points, the set of index values indicating hopping frequency sequences used by the plurality of access points; means for detecting that synchronization between device 200 and an access point, of the plurality of access points, has been lost; means for monitoring for periodic advertisements, broadcast from at least one additional access point of the plurality of access points, according to the hopping frequency sequences indicated by the set of index values; means for detecting a periodic advertisement broadcast from an additional access point, of the plurality of access points, based at least in part on monitoring for periodic advertisements; or the like. In some aspects, such means may include one or more components of device 200 described in connection with FIG. 2, such as bus 205, processor 210, memory 215, storage component 220, input component 225, output component 230, and/or communication component 235.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

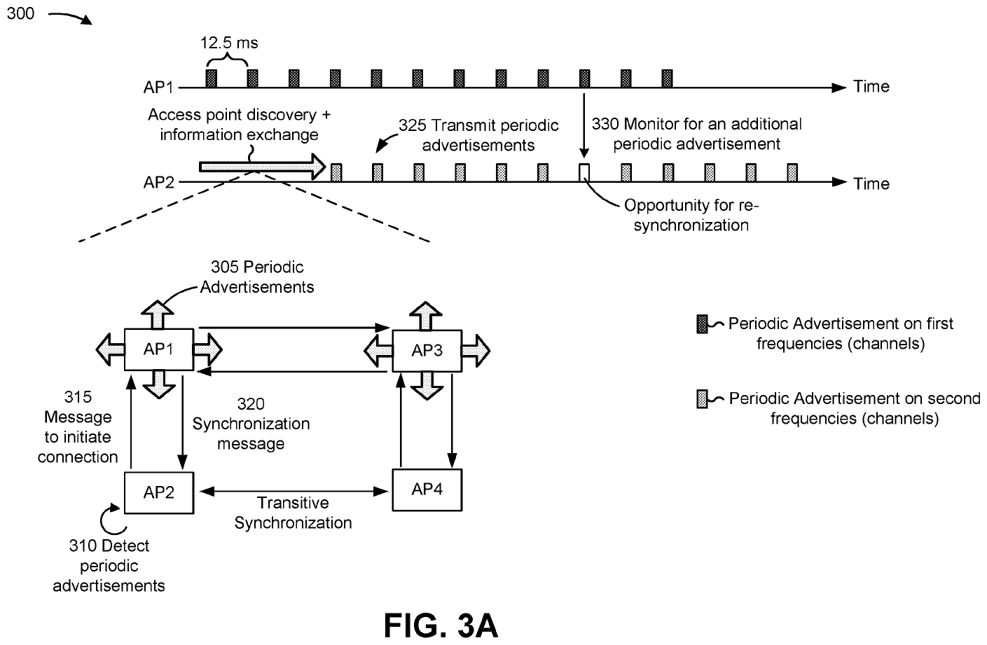

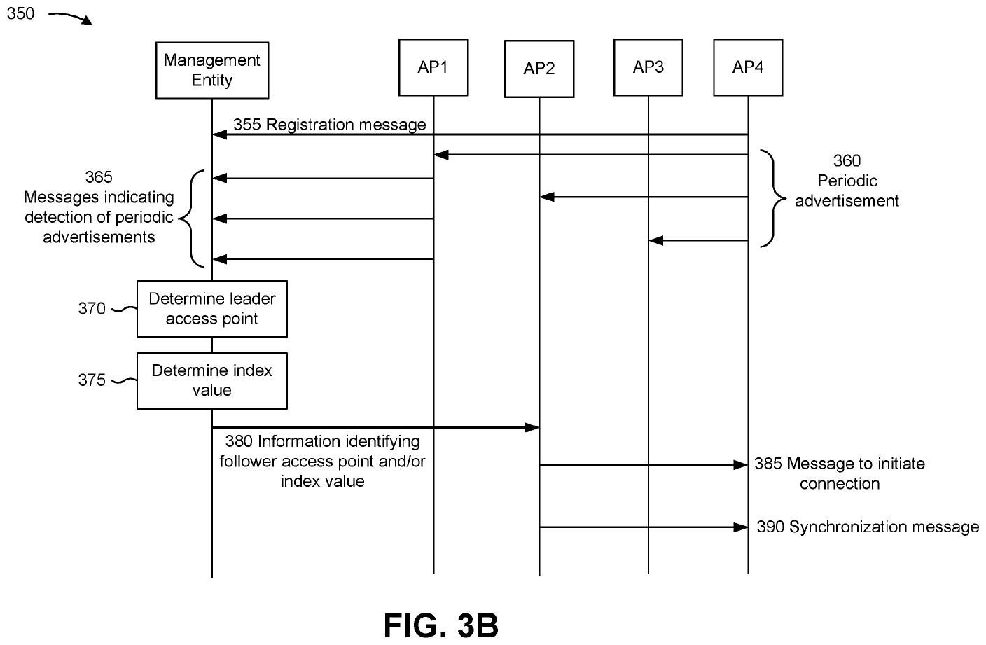

FIG. 3A is a diagram illustrating an example 300 associated with discovery and synchronization between access points, in accordance with the present disclosure. As shown, example 300 includes multiple access points (e.g., access points 110), shown as AP1 to AP4. The access points may each be communicatively connected to a management entity (e.g., management entity 130). In some aspects, the access points and/or the management entity may be included in a wireless communication system, such as an ESL system. The wireless communication system may use a wireless communication technology, such as BLE.

As used herein, “transmission timing” or “periodic advertisement timing” may refer to a timing or schedule by which a device (e.g., an access point) transmits communications or periodic advertisements. For example, two devices that use (e.g., that are synchronized to) the same periodic advertisement timing may transmit periodic advertisements concurrently.

As shown by reference number 305, an access point AP1 may transmit (e.g., broadcast) periodic advertisements (e.g., a train of periodic advertisements). The periodic advertisements may be unidirectional broadcast messages. The access point AP1 may transmit periodic advertisements in accordance with a periodic advertisement with multiple response (PAwMR) schedule. Moreover, the access point AP1 may transmit the periodic advertisements using a first HFS. The first HFS may be an HFS configured for the access point AP1 (e.g., if the access point AP1 is not a follower of another access point), or the first HFS may be shifted from a reference HFS based at least in part on a first index value associated with (e.g., selected by) the access point AP1.

As shown by reference number 310, an access point (AP2) may detect at least one periodic advertisement broadcast from the access point AP1 (e.g., by scanning known channels on which the access point AP1 performs transmissions and/or by scanning, or taking a snapshot of, an entire band). That is, the access point AP2 may discover the access point AP1. In some aspects, the access point AP2 may listen on one or more advertisement channels (e.g., legacy advertisement channels) to detect information that enables the access point AP2 to follow and synchronize with the access point AP1, thereby enabling the access point AP2 to monitor for the periodic advertisement(s). In some aspects, the access point AP2 may monitor for (e.g., listen for) and detect the periodic advertisement(s) prior to initiation of periodic advertisement transmissions by the access point AP2 (which may be referred to as a “detect before proceed” policy). For example, in a boot sequence during starting (or re-starting) of the access point AP2, the access point AP2 may listen for periodic advertisements from other access points before starting periodic advertisement transmissions. In some aspects, access points (e.g., isolated access points), such as the access point AP2, may periodically listen for periodic advertisements from neighboring access points.

As shown by reference number 315, based on detecting a periodic advertisement from the access point AP1, the access point AP2 may transmit, and the access point AP1 may receive, a message (e.g., an unsolicited message) to initiate a connection between the access point AP1 and the access point AP2. As shown by reference number 320, following the connection, or as part of the connection procedure, the access point AP1 may transmit, and the access point AP2 may receive, a synchronization message. The synchronization message may identify the periodic advertisement timing (e.g., the PawMR schedule) used by the access point AP1. For example, the synchronization message may include PAST information that indicates the periodic advertising timing used by the access point AP1 (e.g., by indicating a time offset used by the access point AP1). In addition, or alternatively, the synchronization message may identify the first HFS used by the access point AP1. For example, the PAST information may also indicate a reference HFS used by the access point AP1, and the first HFS may be the reference HFS or an HFS that is shifted (e.g., frequency shifted) from the reference HFS. For example, if an HFS is shifted from a reference HFS, then at all frequency instances in a frequency sequence, a channel index of the HFS is different from a channel index of the reference HFS. In some aspects, the synchronization message may identify the first HFS used by the access point AP1 by indicating the first index value associated with the access point AP1 (e.g., the first HFS may be determined using the first index value and the reference HFS). For example, the synchronization message may indicate a set of index values that includes the first index value and/or one or more additional index values, associated with additional access points, known to the access point AP1. In some aspects, the set of index values may include an index value for the access point AP2 that indicates an HFS to be used by the access point AP2.

The exchange of periodic advertising timing information (e.g., the exchange of PAST information) may enable the access point AP2 to synchronize with the access point AP1. Accordingly, in the same manner, multiple additional access points may synchronize to the same periodic advertisement timing. For example, as shown, access point AP3 may also synchronize with access point AP1, and access point AP4 may synchronize with access point AP3 (thereby resulting in access point AP4 being synchronized with access point AP2 by transitive synchronization). In this way, multiple access points may become time synchronized with each other.

As shown by reference number 325, based on receiving the synchronization message, the access point AP2 may transmit periodic advertisements (e.g., transmissions on a data channel) synchronized with the periodic advertisement timing (e.g., the PAwMR schedule) used by the access point AP1. In this way, periodic advertisements are transmitted concurrently by the access point AP1 and the access point AP2. However, the access point AP2 may transmit the periodic advertisements according to a second HFS. The second HFS may be offset from (e.g., orthogonal to) the first HFS used by the access point AP1 or a reference HFS. In other words, each of the access points (e.g., with physically overlapping coverage areas) may use an HFS that is orthogonal to an HFS of any of the other access points. By using orthogonal HFSs, interference among the access points may be avoided despite the access points being time synchronized.

The second HFS may be based at least in part on a second index value (e.g., different from the first index value) associated with the access point AP2. For example, each of the access points (e.g., with physically overlapping coverage areas) may be associated with a different index value from any of the other access points. Accordingly, based at least in part on the set of index values identified to the access point AP2, the access point AP2 may select the second index value to achieve an HFS (e.g., in a radio frequency range of the access point AP2) that is orthogonal to every other HFS currently in use. In some aspects, the second HFS may be shifted relative to the first HFS or the reference HFS based at least in part on the second index value. For example, the second HFS may be determined according to Equation 1 below:

$${HFS}_{i} = ( {HFS}_{0} + {index}_{i} ) mod 37 \qquad Equation 1$$

where HFS₀ is the reference HFS, HFSᵢ is the HFS being determined, and indexᵢ is the index value used to determine the HFS. Equation 1 uses a value of 37 for the modulo operation because a BLE system uses 37 data channels. However, a different value for the modulo operation may be used (e.g., corresponding to a quantity of channels) in other systems.

In some aspects, an index value may indicate an HFS in a manner other than as described above. That is, an index value may be any means to identify a hopping frequency channel (or “channel selection”) sequence. For example, each access point and each wireless communication device may be configured with a set of HFSs, and an index value may map to a particular HFS of the set of HFSs. Thus, indication of a set of index values, as described herein, may refer to the indication of all active (e.g., in use) HFSs of the set of HFSs.

In some aspects, the access point AP1 may transmit, and one or more wireless communication devices (e.g., wireless communication devices 120) may receive, information identifying the periodic advertisement timing (e.g., PAST information) used by the access point AP1. For example, the access point AP1 may transmit the information in connection with onboarding the wireless communication device(s) to the access point AP1. In some aspects, the access point AP2 may transmit, and one or more wireless communication devices (e.g., wireless communication devices 120) may receive, information identifying the periodic advertisement timing (e.g., PAST information) used by the access point AP2. For example, the access point AP2 may transmit the information to wireless communication devices already onboarded with the access point AP2, or the access point AP2 may cause the wireless communication devices to repeat an onboarding procedure with the access point AP2 during which the information is transmitted.

In some aspects, the access point AP1 may transmit (e.g., via broadcast), and one or more wireless communication devices (e.g., wireless communication devices 120) synchronized to the access point AP1 may receive, information identifying a set of (e.g., one or more) index values indicating HFSs used by one or more access points. For example, the set of index values may include the first index value associated with the access point AP1, the second index value associated with the access point AP2, and/or one or more additional index values, associated with additional access points, known to the access point AP1. Similarly, in some aspects, the access point AP2 may transmit (e.g., via broadcast), and one or more wireless communication devices (e.g., wireless communication devices 120) synchronized to the access point AP2 may receive, information identifying a set of (e.g., one or more) index values indicating HFSs used by one or more access points. For example, the one or more index values may include the first index value associated with the access point AP1, the second index value associated with the access point AP2, and/or one or more additional index values, associated with additional access points, known to the access point AP2. In some aspects, the access point AP1 and/or the access point AP1 may receive, from the management entity, information indicating the index values that are in use (e.g., valid indexes) for one or more additional access points.

Over time (e.g., due to clock drift), the periodic advertisement timing used by the access point AP1 and the access point AP2 may become misaligned. As shown by reference number 330, the access point AP2 may monitor (e.g., sporadically) for an additional periodic advertisement from the access point AP1 in a monitoring opportunity. In other words, the access point AP2 may sacrifice a periodic advertisement transmission (e.g., for a particular group of wireless communication devices) in order to monitor for the additional periodic advertisement from the access point AP1. In some aspects, the monitoring opportunity, in which the access point AP2 monitors for the additional periodic advertisement, may be based at least in part on an expected clock drift between the access point AP1 and the access point AP2. Based on a timing of the additional periodic advertisement, the periodic advertisement timing may be realigned between the access point AP1 and the access point AP2. For example, the access point AP2 may realign with the periodic advertisement timing used by the access point AP1 based at least in part on a timing of the additional periodic advertisement (e.g., based at least in part on a difference between the actual timing of the additional periodic advertisement and an expected timing of the additional periodic advertisement).

In some examples, an access point that uses a transmission timing or schedule (e.g., a periodic advertisement timing or schedule) that is followed by another access point may be referred to as a “leader access point,” and an access point that synchronizes its transmission timing or schedule to the transmission timing or schedule of another access point may be referred to as a “follower access point.” In some cases, an access point may be both a leader access point and a follower access point. For example, the transmission timing or schedule used by a first access point may be followed by a second access point, and a third access point may follow the transmission timing or schedule used by the second access point. Thus, in this example, the second access point is both a leader access point and a follower access point.

As indicated above, FIG. 3A is provided as an example. Other examples may differ from what is described with respect to FIG. 3A.

FIG. 3B is a diagram illustrating an example 350 associated with discovery and synchronization between access points, in accordance with the present disclosure. As shown, example 350 includes multiple access points (e.g., access points 110), shown as AP1 to AP4, and a management entity (e.g., management entity 130). The access points may each be communicatively connected to the management entity. In some aspects, the access points and/or the management entity may be included in a wireless communication system, such as an ESL system. The wireless communication system may use a wireless communication technology, such as BLE.

As shown by reference number 355, an access point AP4 may transmit, and the management entity may receive, a registration message. The registration message may indicate an identity of the access point AP4 (e.g., a BD_ADDR or other information sufficient for the management entity to identify the follower access point). The access point AP4 may transmit the registration message based at least in part on the access point AP4 being unsynchronized with any other access point. For example, the access point AP4 may be a new access point to the wireless communication system or may have lost a previous synchronization.

As shown by reference number 360, the access point AP4 may transmit periodic advertisements, and a plurality of access points (AP1, AP2, and AP3) may detect one or more of the periodic advertisements. The access point AP4 may transmit the periodic advertisements in a similar manner as described above. In some aspects, the periodic advertisements may indicate an identity of the access point AP4 (e.g., a BD_ADDR).

As shown by reference number 365, based on detecting the periodic advertisements, the plurality of access points AP1, AP2, AP3 may transmit, and the management entity may receive, respective messages indicating detection of a periodic advertisement from the access point AP4. A message from an access point may indicate an identity of the access point AP4 (e.g., from which a periodic advertisement was detected). Additionally, or alternatively, the message may indicate a signal strength between the access point and the access point AP4. For example, the message may include a received signal strength indication (RSSI).

As shown by reference number 370, the management entity may determine (e.g., select) a leader access point, from among the plurality of access points AP1, AP2, AP3, for the access point AP4. For example, the management entity may compare signal strengths reported by the plurality of access points AP1, AP2, AP3, and the management entity may select the access point that reported the best signal strength (e.g., the highest RSSI) as the leader access point for the access point AP4.

As shown by reference number 375, the management entity may determine an index value indicating an HFS that is to be used by the access point AP4. For example, the plurality of access points AP1, AP2, AP3 may be associated with respective index values indicating HFSs used by the plurality of access points AP1, AP2, AP3 (e.g., where an HFS is orthogonal to each of the other HFSs), and the management entity may determine an index value for the access point AP4 that is different from each of the index values associated with the plurality of access points AP1, AP2, AP3. In other words, the index value determined for the access point AP4 may indicate an HFS that is orthogonal to each of the HFSs used by the plurality of access points AP1, AP2, AP3. An index value may indicate an HFS in a similar manner as described in connection with FIG. 3A.

As shown by reference number 380, the management entity may transmit, and the determined leader access point (AP2, as shown) may receive, information (e.g., a synchronization message) that identifies the access point AP4, that the leader access point AP2 is to lead, and/or the index value determined for the access point AP4 by the management entity. The management entity may transmit this information to cause the leader access point AP2 to establish a connection with the access point AP4. As shown by reference number 385, the leader access point AP2 may transmit, and the access point AP4 may receive, a message to initiate a connection between the leader access point AP2 and the access point AP4, and the leader access point AP2 and the access point AP4 may establish the connection, as described herein.

As shown by reference number 390, following the connection, or as part of the connection procedure, the leader access point AP2 may transmit, and the access point AP4 may receive, a synchronization message that identifies the periodic advertisement timing (e.g., the PAwMR schedule) used by the leader access point AP2 (e.g., PAST information) and/or a set of index values, as described herein. The set of index values may include index values associated with the plurality of access points AP1, AP2, AP3 (e.g., the index values indicate HFSs used by the plurality of access points AP1, AP2, AP3). Additionally, or alternatively, the set of index values may include the index value determined for the access point AP4 by the management entity. Accordingly, based on receiving the synchronization message, the access point AP4 may transmit periodic advertisements (e.g., a periodic advertisement train) synchronized with the periodic advertisement timing used by the leader access point AP2 and using an HFS indicated by the index value, as described herein.

As indicated above, FIG. 3B is provided as an example. Other examples may differ from what is described with respect to FIG. 3B.

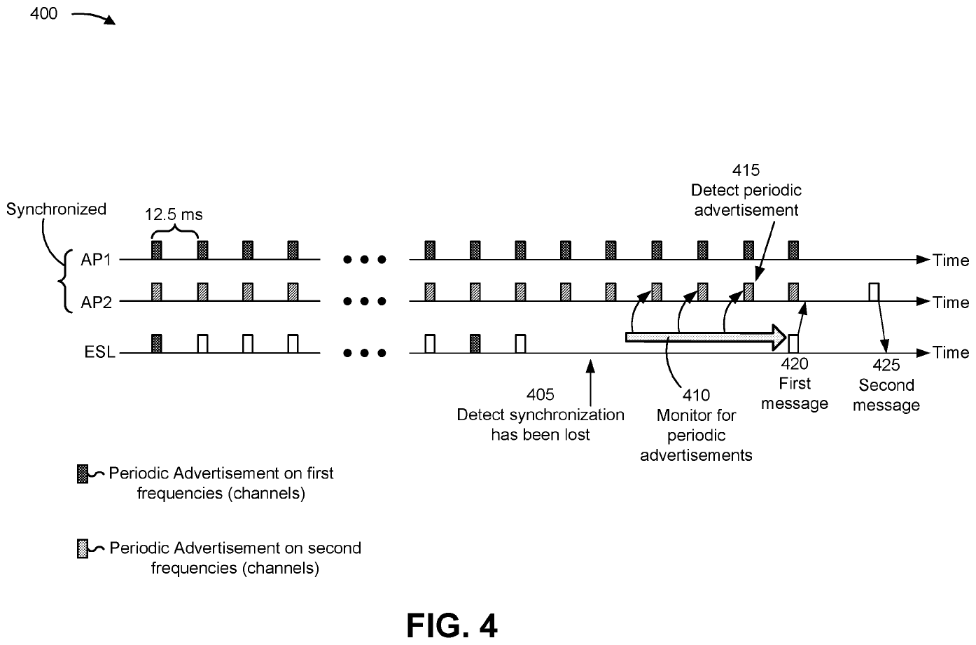

FIG. 4 is a diagram illustrating an example 400 associated with handover of a wireless communication device, in accordance with the present disclosure. As shown, example 400 includes multiple access points (e.g., access points 110), shown as a first access point (AP1) and a second access point (AP2), and at least one wireless communication device (e.g., wireless communication device 120). The access points and the wireless communication device may be included in a wireless communication system, such as an ESL system. The wireless communication system may use a wireless communication technology, such as BLE. In some aspects, the wireless communication device is, includes, or is included in an ESL.

In some aspects, the wireless communication device may be included in a wireless communication device group. Wireless communication devices of the wireless communication device group may monitor for periodic advertisements, from an access point with which the wireless communication devices are synchronized, in periodic intervals that are less frequent than a frequency at which the periodic advertisements are transmitted by the access point. For example, the wireless communication devices of the wireless communication device group may monitor for periodic advertisements every 1.6 seconds, whereas the access point may transmit the periodic advertisements every 12.5 milliseconds (ms). Accordingly, the wireless communication devices may enter a sleep state or another type of low power state for a portion of the periodic interval in which the wireless communication devices are not monitoring for periodic advertisements. In some aspects, a first periodic advertisement transmission of a cycle may be monitored by a first wireless communication device group, a second periodic advertisement transmission of a cycle (e.g., occurring 12.5 ms after the first periodic advertisement transmission) may be monitored by a second wireless communication device group, and so forth. A periodic advertisement timing of the access points may be synchronized, as described in connection with FIG. 3A and/or FIG. 3B.

The wireless communication device and the first access point may have established synchronization prior to operations shown in FIG. 4. Accordingly, the wireless communication device may receive, from the first access point, information identifying the periodic advertisement timing (e.g., PAST information) and information identifying a set of index values (e.g., a plurality of index values) respectively associated with a plurality of access points (e.g., including the first access point and/or the second access point), as described in connection with FIG. 3A, prior to operations shown in FIG. 4. For example, the set of index values may indicate HFSs used by the plurality of access points.

As shown by reference number 405, the wireless communication device may detect that synchronization between the wireless communication device and the first access point (e.g., the one access point associated with the wireless communication device and for which the wireless communication device monitors periodic advertisements) has been lost. As shown by reference number 410, based on detecting that synchronization has been lost, the wireless communication device may monitor for periodic advertisements broadcast from one or more additional access points, such as the second access point, of the plurality of access points. Due to the time coordination of the access points, the wireless communication device does not need additional information relating to the periodic advertisement timing of the plurality of access points in order to monitor for periodic advertisements. Accordingly, the wireless communication device may monitor for the periodic advertisements from the one or more additional access points according to the same periodic advertisement timing used by the first access point. In this way, the wireless communication device may efficiently identify an additional access point and quickly engage with the additional access point to enter into an association with the additional access point.

The wireless communication device may monitor for the periodic advertisements (e.g., in one or more channels) according to the HFSs indicated by the set of index values. For example, for each index value, the wireless communication device may determine an HFS based at least in part on the index value (as described in connection with FIG. 3A). Continuing with the example, the wireless communication device may monitor for periodic advertisements in channels indicated by the HFS. As described herein, the HFSs for the plurality of access points may be time aligned. However, at any given time, each of the HFSs may use a different channel from any of the other HFSs to avoid interference.

In some aspects, to monitor for periodic advertisements, the wireless communication device may search for periodic advertisements in one or more time periods designated for the wireless communication device group that includes the wireless communication device. However, searching by the wireless communication device may not be limited to those time periods. For example, the wireless communication device may monitor for periodic advertisements in a first time period associated with periodic advertisement monitoring for a first wireless communication device group that includes the wireless communication device and in a second time period associated with periodic advertisement monitoring for a second wireless communication device group that does not include the wireless communication device. Accordingly, the wireless communication device may monitor for periodic advertisements in sub-frame intervals (e.g., 12.5 ms intervals).

As shown by reference number 415, based on monitoring for periodic advertisements, the wireless communication device may detect a periodic advertisement (e.g., a periodic advertisement train) broadcast from the second access point. In some aspects, the wireless communication device may detect periodic advertisements from multiple access points, and the wireless communication device may select (e.g., based on signal strength measurements associated with the periodic advertisements or another metric) the second access point from among the multiple access points.

As shown by reference number 420, based on detecting the periodic advertisement from the second access point, the wireless communication device may transmit, and the second access point may receive, a first message to initiate handover of the wireless communication device to the second access point. The first message may indicate, to the second access point, the presence of the wireless communication device. For example, the first message may indicate an identity of the wireless communication device (e.g., a BD_ADDR or other information sufficient for the second access point to identify the wireless communication device). In some aspects, the wireless communication device may transmit the first message in a response slot (e.g., of the PAwMR train of the second access point) reserved by the second access point for such first messages. In some aspects, the first message may be an unsolicited message. In some aspects, the first message is not encrypted. In some aspects, the wireless communication device may transmit the first message one or more times (e.g., the wireless communication device may repeat transmission of the first message) until the wireless communication device has been onboarded to the second access point (or another access point).

As shown by reference number 425, based on successful reception of the first message by the second access point, the second access point may transmit, and the wireless communication device may receive, a second message (e.g., an AUX_CONNECT_REQ message) to establish synchronization between the wireless communication device and the second access point. Thus, synchronization between the wireless communication device and the second access point may be established independently of (e.g., without use of) broadcasting on advertisement channels. In other words, the synchronization may be established independently of (e.g., without use of) the full onboarding procedure described above. In some aspects, the second access point may transmit the second message in a transmission opportunity (e.g., for transmitting such second messages) that is fixed. In this way, the wireless communication device may be onboarded to the second access point using a lightweight and efficient procedure. In some aspects, the first message and/or the second message may include an exchange of security elements (e.g., security credentials) between the wireless communication device and the second access point.

As indicated above, FIG. 4 is provided as an example. Other examples may differ from what is described with respect to FIG. 4.

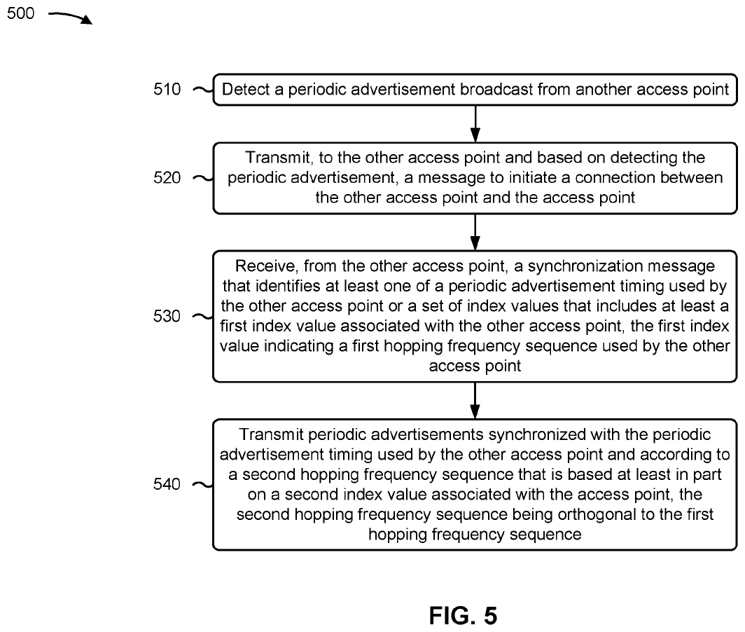

FIG. 5 is a flowchart of an example process 500 associated with access point synchronization. In some aspects, one or more process blocks of FIG. 5 are performed by an access point (e.g., access point 110). In some aspects, one or more process blocks of FIG. 5 are performed by another device or a group of devices separate from or including the access point, such as a wireless communication device (e.g., wireless communication device 120) and/or a management entity (e.g., management entity 130). Additionally, or alternatively, one or more process blocks of FIG. 5 may be performed by one or more components of device 200, such as processor 210, memory 215, storage component 220, input component 225, output component 230, and/or communication component 235.

As shown in FIG. 5, process 500 may include detecting a periodic advertisement broadcast from another access point (block 510). For example, the access point may detect a periodic advertisement broadcast from another access point, as described above.

As further shown in FIG. 5, process 500 may include transmitting, to the other access point and based on detecting the periodic advertisement, a message to initiate a connection between the other access point and the access point (block 520). For example, the access point may transmit, to the other access point and based on detecting the periodic advertisement, a message to initiate a connection between the other access point and the access point, as described above.

As further shown in FIG. 5, process 500 may include receiving, from the other access point, a synchronization message that identifies at least one of a periodic advertisement timing used by the other access point or a set of index values that includes at least a first index value associated with the other access point, the first index value indicating a first hopping frequency sequence used by the other access point (block 530). For example, the access point may receive, from the other access point, a synchronization message that identifies at least one of a periodic advertisement timing used by the other access point or a set of index values that includes at least a first index value associated with the other access point. In some aspects, the first index value indicates a first hopping frequency sequence used by the other access point, as described above.

As further shown in FIG. 5, process 500 may include transmitting periodic advertisements synchronized with the periodic advertisement timing used by the other access point and according to a second hopping frequency sequence that is based at least in part on a second index value associated with the access point, the second hopping frequency sequence being orthogonal to the first hopping frequency sequence (block 540). For example, the access point may transmit periodic advertisements synchronized with the periodic advertisement timing used by the other access point and according to a second hopping frequency sequence that is based at least in part on a second index value associated with the access point. In some aspects, the second hopping frequency sequence is orthogonal to the first hopping frequency sequence, as described above.

Process 500 may include additional aspects, such as any single aspect or any combination of aspects described below and/or in connection with one or more other processes described elsewhere herein.

In a first aspect, process 500 includes monitoring for an additional periodic advertisement, broadcast from the other access point, where the periodic advertisement timing is realigned between the other access point and the access point based at least in part on a timing of the additional periodic advertisement.

In a second aspect, alone or in combination with the first aspect, process 500 includes transmitting, to one or more wireless communication devices, information identifying the periodic advertisement timing.

In a third aspect, alone or in combination with one or more of the first and second aspects, process 500 includes transmitting, to one or more wireless communication devices, information identifying one or more index values indicating hopping frequency sequences, the one or more index values including at least one of the first index value or the second index value.

In a fourth aspect, alone or in combination with one or more of the first through third aspects, process 500 includes receiving, from a wireless communication device, a first message to initiate handover of the wireless communication device to the access point, the first message indicating an identity of the wireless communication device, and transmitting, to the wireless communication device, a second message to establish synchronization between the wireless communication device and the access point independently of broadcasting on advertisement channels.

In a fifth aspect, alone or in combination with one or more of the first through fourth aspects, the periodic advertisement is detected prior to initiation of periodic advertisement transmissions by the access point.

In a sixth aspect, alone or in combination with one or more of the first through fifth aspects, the periodic advertising timing is indicated by PAST information.

In a seventh aspect, alone or in combination with one or more of the first through sixth aspects, the first hopping frequency sequence is shifted from a reference hopping frequency sequence based at least in part on the first index value, and the second hopping frequency sequence is shifted from the reference hopping frequency sequence based at least in part on the second index value.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

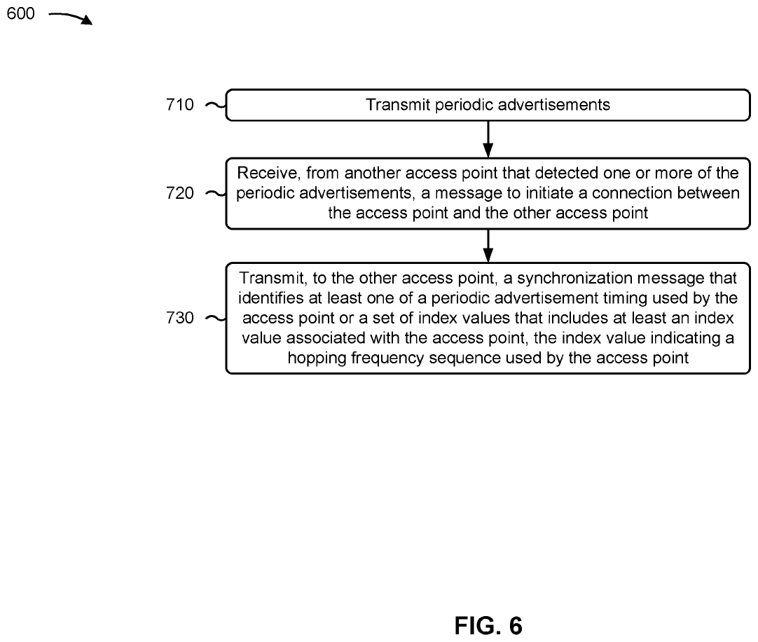

FIG. 6 is a flowchart of an example process 600 associated with access point synchronization. In some aspects, one or more process blocks of FIG. 6 are performed by an access point (e.g., access point 110). In some aspects, one or more process blocks of FIG. 6 are performed by another device or a group of devices separate from or including the access point, such as a wireless communication device (e.g., wireless communication device 120) and/or a management entity (e.g., management entity 130). Additionally, or alternatively, one or more process blocks of FIG. 6 may be performed by one or more components of device 200, such as processor 210, memory 215, storage component 220, input component 225, output component 230, and/or communication component 235.

As shown in FIG. 6, process 600 may include transmitting periodic advertisements (block 610). For example, the access point may transmit periodic advertisements, as described above.

As further shown in FIG. 6, process 600 may include receiving, from another access point that detected one or more of the periodic advertisements, a message to initiate a connection between the access point and the other access point (block 620). For example, the access point may receive, from another access point that detected one or more of the periodic advertisements, a message to initiate a connection between the access point and the other access point, as described above.

As further shown in FIG. 6, process 600 may include transmitting, to the other access point, a synchronization message that identifies at least one of a periodic advertisement timing used by the access point or a set of index values that includes at least an index value associated with the access point, the index value indicating a hopping frequency sequence used by the access point (block 630). For example, the access point may transmit, to the other access point, a synchronization message that identifies at least one of a periodic advertisement timing used by the access point or a set of index values that includes at least an index value associated with the access point, the index value indicating a hopping frequency sequence used by the access point, as described above.

Process 600 may include additional aspects, such as any single aspect or any combination of aspects described below and/or in connection with one or more other processes described elsewhere herein.

In a first aspect, process 600 includes transmitting, to one or more wireless communication devices, information identifying the periodic advertisement timing.

In a second aspect, alone or in combination with the first aspect, process 600 includes transmitting, to one or more wireless communication devices, information identifying one or more index values indicating hopping frequency sequences, the one or more index values including at least the index value.

In a third aspect, alone or in combination with one or more of the first and second aspects, process 600 includes receiving, from a wireless communication device, a first message to initiate handover of the wireless communication device to the access point, the first message indicating an identity of the wireless communication device, and transmitting, to the wireless communication device, a second message to establish synchronization between the wireless communication device and the access point independently of broadcasting on advertisement channels.

In a fourth aspect, alone or in combination with one or more of the first through third aspects, the periodic advertising timing is indicated by PAST information.

In a fifth aspect, alone or in combination with one or more of the first through fourth aspects, the hopping frequency sequence is shifted from a reference hopping frequency sequence based at least in part on the index value.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

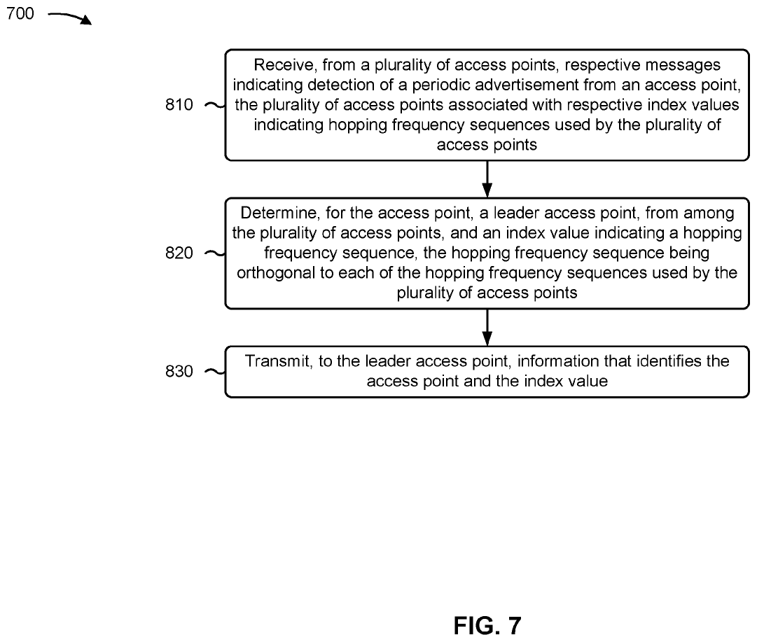

FIG. 7 is a flowchart of an example process 700 associated with access point synchronization. In some aspects, one or more process blocks of FIG. 7 are performed by a management entity (e.g., management entity 130). In some aspects, one or more process blocks of FIG. 7 are performed by another device or a group of devices separate from or including the management entity, such as an access point (e.g., access point 110) and/or a wireless communication device (e.g., wireless communication device 120). Additionally, or alternatively, one or more process blocks of FIG. 7 may be performed by one or more components of device 200, such as processor 210, memory 215, storage component 220, input component 225, output component 230, and/or communication component 235.

As shown in FIG. 7, process 700 may include receiving, from a plurality of access points, respective messages indicating detection of a periodic advertisement from an access point, the plurality of access points associated with respective index values indicating hopping frequency sequences used by the plurality of access points (block 710). For example, the management entity may receive, from a plurality of access points, respective messages indicating detection of a periodic advertisement from an access point. In some aspects, the plurality of access points may be associated with respective index values indicating hopping frequency sequences used by the plurality of access points, as described above.

As further shown in FIG. 7, process 700 may include determining, for the access point, a leader access point, from among the plurality of access points, and an index value indicating a hopping frequency sequence, the hopping frequency sequence being orthogonal to each of the hopping frequency sequences used by the plurality of access points (block 720). For example, the management entity may determine, for the access point, a leader access point, from among the plurality of access points, and an index value indicating a hopping frequency sequence. In some aspects, the hopping frequency sequence may be orthogonal to each of the hopping frequency sequences used by the plurality of access points, as described above.

As further shown in FIG. 7, process 700 may include transmitting, to the leader access point, information that identifies the access point and the index value (block 830). For example, the management entity may transmit, to the leader access point, information that identifies the access point and the index value, as described above.

Process 700 may include additional aspects, such as any single aspect or any combination of aspects described below and/or in connection with one or more other processes described elsewhere herein.

In a first aspect, the respective messages indicate respective received signal strength indications.

In a second aspect, alone or in combination with the first aspect, the leader access point is determined based at least in part on respective signal strengths between the plurality of access points and the access point.

In a third aspect, alone or in combination with one or more of the first and second aspects, the information is transmitted to the leader access point to cause the leader access point to establish a connection with the access point.

Although FIG. 7 shows example blocks of process 700, in some aspects, process 700 includes additional blocks, fewer blocks, different blocks, or differently arranged blocks than those depicted in FIG. 7. Additionally, or alternatively, two or more of the blocks of process 700 may be performed in parallel.

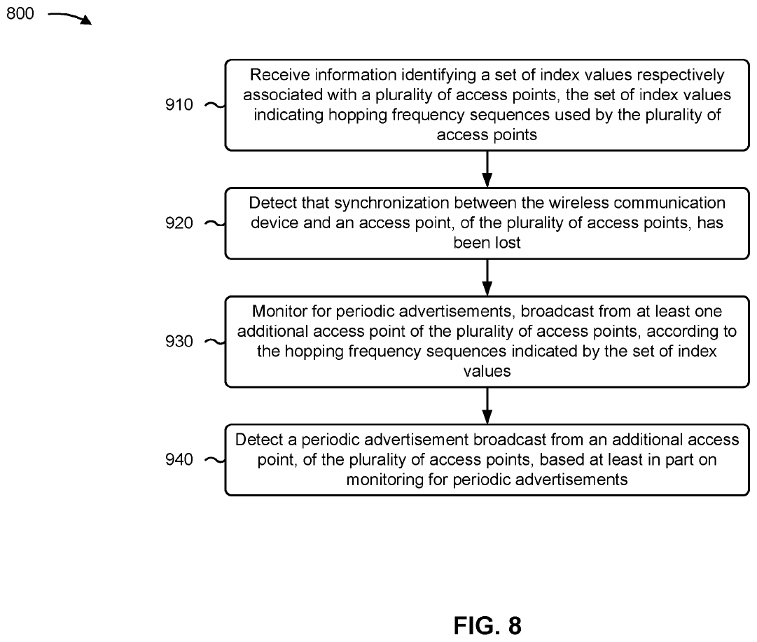

FIG. 8 is a flowchart of an example process 800 associated with handover of a wireless communication device. In some aspects, one or more process blocks of FIG. 8 are performed by a wireless communication device (e.g., wireless communication device 120). In some aspects, one or more process blocks of FIG. 8 are performed by another device or a group of devices separate from or including the wireless communication device, such as an access point (e.g., access point 110) and/or a management entity (e.g., management entity 130). Additionally, or alternatively, one or more process blocks of FIG. 8 may be performed by one or more components of device 200, such as processor 210, memory 215, storage component 220, input component 225, output component 230, and/or communication component 235.

As shown in FIG. 8, process 800 may include receiving information identifying a set of index values respectively associated with a plurality of access points, the set of index values indicating hopping frequency sequences used by the plurality of access points (block 810). For example, the wireless communication device may receive information identifying a set of index values respectively associated with a plurality of access points. In some aspects, the set of index values may indicate hopping frequency sequences used by the plurality of access points, as described above.

As further shown in FIG. 8, process 800 may include detecting that synchronization between the wireless communication device and an access point, of the plurality of access points, has been lost (block 820). For example, the wireless communication device may detect that synchronization between the wireless communication device and an access point, of the plurality of access points, has been lost, as described above.

As further shown in FIG. 8, process 800 may include monitoring for periodic advertisements, broadcast from at least one additional access point of the plurality of access points, according to the hopping frequency sequences indicated by the set of index values (block 830). For example, the wireless communication device may monitor for periodic advertisements, broadcast from at least one additional access point of the plurality of access points, according to the hopping frequency sequences indicated by the set of index values, as described above.

As further shown in FIG. 8, process 800 may include detecting a periodic advertisement broadcast from an additional access point, of the plurality of access points, based at least in part on monitoring for periodic advertisements (block 840). For example, the wireless communication device may detect a periodic advertisement broadcast from an additional access point, of the plurality of access points, based at least in part on monitoring for periodic advertisements, as described above.

Process 800 may include additional aspects, such as any single aspect or any combination of aspects described below and/or in connection with one or more other processes described elsewhere herein.

In a first aspect, process 800 includes transmitting, to the additional access point, a first message to initiate handover of the wireless communication device to the additional access point, the first message indicating an identity of the wireless communication device, and receiving, from the additional access point, a second message to establish synchronization between the wireless communication device and the additional access point independently of broadcasting on advertisement channels.

In a second aspect, alone or in combination with the first aspect, the periodic advertisements are monitored in a first time period associated with periodic advertisement monitoring for a first wireless communication device group that includes the wireless communication device and in a second time period associated with periodic advertisement monitoring for a second wireless communication device group that does not include the wireless communication device.

In a third aspect, alone or in combination with the first aspect, periodic advertisement transmissions of the plurality of access points are time synchronized.

Although FIG. 8 shows example blocks of process 800, in some aspects, process 800 includes additional blocks, fewer blocks, different blocks, or differently arranged blocks than those depicted in FIG. 8. Additionally, or alternatively, two or more of the blocks of process 800 may be performed in parallel.

The following provides an overview of some Aspects of the present disclosure:

Aspect 1: A method performed by an access point, comprising: detecting a periodic advertisement broadcast from another access point; transmitting, to the other access point and based on detecting the periodic advertisement, a message to initiate a connection between the other access point and the access point; receiving, from the other access point, a synchronization message that identifies at least one of a periodic advertisement timing used by the other access point or a set of index values that includes at least a first index value associated with the other access point, the first index value indicating a first hopping frequency sequence used by the other access point; and transmitting periodic advertisements synchronized with the periodic advertisement timing used by the other access point and according to a second hopping frequency sequence that is based at least in part on a second index value associated with the access point, the second hopping frequency sequence being orthogonal to the first hopping frequency sequence.

Aspect 2: The method of Aspect 1, further comprising: monitoring for an additional periodic advertisement, broadcast from the other access point, wherein the periodic advertisement timing is realigned between the other access point and the access point based at least in part on a timing of the additional periodic advertisement.

Aspect 3: The method of any of Aspects 1-2, further comprising: transmitting, to one or more wireless communication devices, information identifying the periodic advertisement timing.

Aspect 4: The method of any of Aspects 1-3, further comprising: transmitting, to one or more wireless communication devices, information identifying one or more index values indicating hopping frequency sequences, the one or more index values including at least one of the first index value or the second index value.

Aspect 5: The method of any of Aspects 1-4, further comprising: receiving, from a wireless communication device, a first message to initiate handover of the wireless communication device to the access point, the first message indicating an identity of the wireless communication device; and transmitting, to the wireless communication device, a second message to establish synchronization between the wireless communication device and the access point independently of broadcasting on advertisement channels.

Aspect 6: The method of any of Aspects 1-5, wherein the periodic advertisement is detected prior to initiation of periodic advertisement transmissions by the access point.

Aspect 7: The method of any of Aspects 1-6, wherein the periodic advertising timing is indicated by periodic advertisement synchronization transfer (PAST) information.

Aspect 8: The method of any of Aspects 1-7, wherein the first hopping frequency sequence is shifted from a reference hopping frequency sequence based at least in part on the first index value, and wherein the second hopping frequency sequence is shifted from the reference hopping frequency sequence based at least in part on the second index value.

Aspect 9: A method performed by an access point, comprising: transmitting periodic advertisements; receiving, from another access point that detected one or more of the periodic advertisements, a message to initiate a connection between the access point and the other access point; and transmitting, to the other access point, a synchronization message that identifies at least one of a periodic advertisement timing used by the access point or a set of index values that includes at least an index value associated with the access point, the index value indicating a hopping frequency sequence used by the access point.

Aspect 10: The method of Aspect 9, further comprising: transmitting, to one or more wireless communication devices, information identifying the periodic advertisement timing.

Aspect 11: The method of any of Aspects 9-10, further comprising: transmitting, to one or more wireless communication devices, information identifying one or more index values indicating hopping frequency sequences, the one or more index values including at least the index value.

Aspect 12: The method of any of Aspects 9-11, further comprising: receiving, from a wireless communication device, a first message to initiate handover of the wireless communication device to the access point, the first message indicating an identity of the wireless communication device; and transmitting, to the wireless communication device, a second message to establish synchronization between the wireless communication device and the access point independently of broadcasting on advertisement channels.

Aspect 13: The method of any of Aspects 9-12, wherein the periodic advertising timing is indicated by periodic advertisement synchronization transfer (PAST) information.

Aspect 14: The method of any of Aspects 9-13, wherein the hopping frequency sequence is shifted from a reference hopping frequency sequence based at least in part on the index value.

Aspect 15: A method performed by a management entity, comprising: receiving, from a plurality of access points, respective messages indicating detection of a periodic advertisement from an access point, the plurality of access points associated with respective index values indicating hopping frequency sequences used by the plurality of access points; determining, for the access point, a leader access point, from among the plurality of access points, and an index value indicating a hopping frequency sequence, the hopping frequency sequence being orthogonal to each of the hopping frequency sequences used by the plurality of access points; and transmitting, to the leader access point, information that identifies the access point and the index value.

Aspect 16: The method of Aspect 15, wherein the respective messages indicate respective received signal strength indications.

Aspect 17: The method of any of Aspects 15-16, wherein the leader access point is determined based at least in part on respective signal strengths between the plurality of access points and the access point.

Aspect 18: The method of any of Aspects 15-17, wherein the information is transmitted to the leader access point to cause the leader access point to establish a connection with the access point.

Aspect 19: A method performed by a wireless communication device, comprising: receiving information identifying a set of index values respectively associated with a plurality of access points, the set of index values indicating hopping frequency sequences used by the plurality of access points; detecting that synchronization between the wireless communication device and an access point, of the plurality of access points, has been lost; monitoring for periodic advertisements, broadcast from at least one additional access point of the plurality of access points, according to the hopping frequency sequences indicated by the set of index values; and detecting a periodic advertisement broadcast from an additional access point, of the plurality of access points, based at least in part on monitoring for periodic advertisements.

Aspect 20: The method of Aspect 19, further comprising: transmitting, to the additional access point, a first message to initiate handover of the wireless communication device to the additional access point, the first message indicating an identity of the wireless communication device; and receiving, from the additional access point, a second message to establish synchronization between the wireless communication device and the additional access point independently of broadcasting on advertisement channels.

Aspect 21: The method of any of Aspects 19-20, wherein the periodic advertisements are monitored in a first time period associated with periodic advertisement monitoring for a first wireless communication device group that includes the wireless communication device and in a second time period associated with periodic advertisement monitoring for a second wireless communication device group that does not include the wireless communication device.

Aspect 22: The method of any of Aspects 19-21, wherein periodic advertisement transmissions of the plurality of access points are time synchronized.

Aspect 23: An apparatus for wireless communication at a device, comprising a processor; memory coupled with the processor; and instructions stored in the memory and executable by the processor to cause the apparatus to perform the method of one or more of Aspects 1-8.

Aspect 24: A device for wireless communication, comprising a memory and one or more processors coupled to the memory, the one or more processors configured to perform the method of one or more of Aspects 1-8.

Aspect 25: An apparatus for wireless communication, comprising at least one means for performing the method of one or more of Aspects 1-8.

Aspect 26: A non-transitory computer-readable medium storing code for wireless communication, the code comprising instructions executable by a processor to perform the method of one or more of Aspects 1-8.

Aspect 27: A non-transitory computer-readable medium storing a set of instructions for wireless communication, the set of instructions comprising one or more instructions that, when executed by one or more processors of a device, cause the device to perform the method of one or more of Aspects 1-8.

Aspect 28: An apparatus for wireless communication at a device, comprising a processor; memory coupled with the processor; and instructions stored in the memory and executable by the processor to cause the apparatus to perform the method of one or more of Aspects 9-14.

Aspect 29: A device for wireless communication, comprising a memory and one or more processors coupled to the memory, the one or more processors configured to perform the method of one or more of Aspects 9-14.

Aspect 30: An apparatus for wireless communication, comprising at least one means for performing the method of one or more of Aspects 9-14.

Aspect 31: A non-transitory computer-readable medium storing code for wireless communication, the code comprising instructions executable by a processor to perform the method of one or more of Aspects 9-14.

Aspect 32: A non-transitory computer-readable medium storing a set of instructions for wireless communication, the set of instructions comprising one or more instructions that, when executed by one or more processors of a device, cause the device to perform the method of one or more of Aspects 9-14.

Aspect 33: An apparatus for wireless communication at a device, comprising a processor; memory coupled with the processor; and instructions stored in the memory and executable by the processor to cause the apparatus to perform the method of one or more of Aspects 15-18.

Aspect 34: A device for wireless communication, comprising a memory and one or more processors coupled to the memory, the one or more processors configured to perform the method of one or more of Aspects 15-18.

Aspect 35: An apparatus for wireless communication, comprising at least one means for performing the method of one or more of Aspects 15-18.

Aspect 36: A non-transitory computer-readable medium storing code for wireless communication, the code comprising instructions executable by a processor to perform the method of one or more of Aspects 15-18.

Aspect 37: A non-transitory computer-readable medium storing a set of instructions for wireless communication, the set of instructions comprising one or more instructions that, when executed by one or more processors of a device, cause the device to perform the method of one or more of Aspects 15-18.

Aspect 38: An apparatus for wireless communication at a device, comprising a processor; memory coupled with the processor; and instructions stored in the memory and executable by the processor to cause the apparatus to perform the method of one or more of Aspects 19-22.

Aspect 39: A device for wireless communication, comprising a memory and one or more processors coupled to the memory, the one or more processors configured to perform the method of one or more of Aspects 19-22.

Aspect 40: An apparatus for wireless communication, comprising at least one means for performing the method of one or more of Aspects 19-22.

Aspect 41: A non-transitory computer-readable medium storing code for wireless communication, the code comprising instructions executable by a processor to perform the method of one or more of Aspects 19-22.

Aspect 42: A non-transitory computer-readable medium storing a set of instructions for wireless communication, the set of instructions comprising one or more instructions that, when executed by one or more processors of a device, cause the device to perform the method of one or more of Aspects 19-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by an access point, comprising:
detecting a periodic advertisement broadcast from another access point;
transmitting, to the other access point and based on detecting the periodic advertisement, a message to initiate a connection between the other access point and the access point;
receiving, from the other access point, a synchronization message that identifies at least one of a periodic advertisement timing used by the other access point or a set of index values that includes at least a first index value associated with the other access point, the first index value indicating a first hopping frequency sequence used by the other access point; and
transmitting periodic advertisements synchronized with the periodic advertisement timing used by the other access point and according to a second hopping frequency sequence that is based at least in part on a second index value associated with the access point, the second hopping frequency sequence being orthogonal to the first hopping frequency sequence.

2. The method of claim 1, further comprising:
monitoring for an additional periodic advertisement, broadcast from the other access point,
wherein the periodic advertisement timing is realigned between the other access point and the access point based at least in part on a timing of the additional periodic advertisement.

3. The method of claim 1, further comprising:
transmitting, to one or more wireless communication devices, information identifying the periodic advertisement timing.

4. The method of claim 1, further comprising:
transmitting, to one or more wireless communication devices, information identifying one or more index values indicating hopping frequency sequences, the one or more index values including at least one of the first index value or the second index value.

5. The method of claim 1, further comprising:
receiving, from a wireless communication device, a first message to initiate handover of the wireless communication device to the access point, the first message indicating an identity of the wireless communication device; and
transmitting, to the wireless communication device, a second message to establish synchronization between the wireless communication device and the access point independently of broadcasting on advertisement channels.

6. The method of claim 1, wherein the periodic advertisement is detected prior to initiation of periodic advertisement transmissions by the access point.

7. The method of claim 1, wherein the periodic advertising timing is indicated by periodic advertisement synchronization transfer (PAST) information.

8. The method of claim 1, wherein the first hopping frequency sequence is shifted from a reference hopping frequency sequence based at least in part on the first index value, and
wherein the second hopping frequency sequence is shifted from the reference hopping frequency sequence based at least in part on the second index value.

9. A method performed by an access point, comprising:
transmitting periodic advertisements;
receiving, from another access point that detected one or more of the periodic advertisements, a message to initiate a connection between the access point and the other access point; and
transmitting, to the other access point, a synchronization message that identifies at least one of a periodic advertisement timing used by the access point or a set of index values that includes at least an index value associated with the access point, the index value indicating a hopping frequency sequence used by the access point.

10. The method of claim 9, further comprising:
transmitting, to one or more wireless communication devices, information identifying the periodic advertisement timing.

11. The method of claim 9, further comprising:
transmitting, to one or more wireless communication devices, information identifying one or more index values indicating hopping frequency sequences, the one or more index values including at least the index value.

12. The method of claim 9, further comprising:
receiving, from a wireless communication device, a first message to initiate handover of the wireless communication device to the access point, the first message indicating an identity of the wireless communication device; and
transmitting, to the wireless communication device, a second message to establish synchronization between the wireless communication device and the access point independently of broadcasting on advertisement channels.

13. The method of claim 9, wherein the periodic advertising timing is indicated by periodic advertisement synchronization transfer (PAST) information.

14. The method of claim 9, wherein the hopping frequency sequence is shifted from a reference hopping frequency sequence based at least in part on the index value.

15. A method performed by a management entity, comprising:
receiving, from a plurality of access points, respective messages indicating detection of a periodic advertisement from an access point,
the plurality of access points associated with respective index values indicating hopping frequency sequences used by the plurality of access points;
determining, for the access point, a leader access point, from among the plurality of access points, and an index value indicating a hopping frequency sequence,
the hopping frequency sequence being orthogonal to each of the hopping frequency sequences used by the plurality of access points; and
transmitting, to the leader access point, information that identifies the access point and the index value.

16. The method of claim 15, wherein the respective messages indicate respective received signal strength indications.

17. The method of claim 15, wherein the leader access point is determined based at least in part on respective signal strengths between the plurality of access points and the access point.

18. The method of claim 15, wherein the information is transmitted to the leader access point to cause the leader access point to establish a connection with the access point.

19. A method performed by a wireless communication device, comprising:
receiving information identifying a set of index values respectively associated with a plurality of access points, the set of index values indicating hopping frequency sequences used by the plurality of access points;
detecting that synchronization between the wireless communication device and an access point, of the plurality of access points, has been lost;
monitoring for periodic advertisements, broadcast from at least one additional access point of the plurality of access points, according to the hopping frequency sequences indicated by the set of index values; and
detecting a periodic advertisement broadcast from an additional access point, of the plurality of access points, based at least in part on monitoring for periodic advertisements.

20. The method of claim 19, further comprising:
transmitting, to the additional access point, a first message to initiate handover of the wireless communication device to the additional access point, the first message indicating an identity of the wireless communication device; and
receiving, from the additional access point, a second message to establish synchronization between the wireless communication device and the additional access point independently of broadcasting on advertisement channels.

21. The method of claim 19, wherein the periodic advertisements are monitored in a first time period associated with periodic advertisement monitoring for a first wireless communication device group that includes the wireless communication device and in a second time period associated with periodic advertisement monitoring for a second wireless communication device group that does not include the wireless communication device.

22. The method of claim 19, wherein periodic advertisement transmissions of the plurality of access points are time synchronized.

23. An access point, comprising:
one or more memories; and
one or more processors, coupled to the one or more memories, configured to:
detect a periodic advertisement broadcast from another access point;
transmit, to the other access point and based on detecting the periodic advertisement, a message to initiate a connection between the other access point and the access point;
receive, from the other access point, a synchronization message that identifies at least one of a periodic advertisement timing used by the other access point or a set of index values that includes at least a first index value associated with the other access point, the first index value indicating a first hopping frequency sequence used by the other access point; and
transmit periodic advertisements synchronized with the periodic advertisement timing used by the other access point and according to a second hopping frequency sequence that is based at least in part on a second index value associated with the access point, the second hopping frequency sequence being orthogonal to the first hopping frequency sequence.

24. The access point of claim 23, wherein the one or more processors are further configured to:
monitor for an additional periodic advertisement, broadcast from the other access point,
wherein the periodic advertisement timing is realigned between the other access point and the access point based at least in part on a timing of the additional periodic advertisement.

25. The access point of claim 23, wherein the one or more processors are further configured to:
transmit, to one or more wireless communication devices, information identifying the periodic advertisement timing.

26. The access point of claim 23, wherein the one or more processors are further configured to:
transmit, to one or more wireless communication devices, information identifying one or more index values indicating hopping frequency sequences, the one or more index values including at least one of the first index value or the second index value.

27. The access point of claim 23, wherein the one or more processors are further configured to:
receive, from a wireless communication device, a first message to initiate handover of the wireless communication device to the access point, the first message indicating an identity of the wireless communication device; and
transmit, to the wireless communication device, a second message to establish synchronization between the wireless communication device and the access point independently of broadcasting on advertisement channels.

28. The access point of claim 23, wherein the periodic advertisement is detected prior to initiation of periodic advertisement transmissions by the access point.

29. The access point of claim 23, wherein the periodic advertising timing is indicated by periodic advertisement synchronization transfer (PAST) information.

30. The access point of claim 23, wherein the first hopping frequency sequence is shifted from a reference hopping frequency sequence based at least in part on the first index value, and
wherein the second hopping frequency sequence is shifted from the reference hopping frequency sequence based at least in part on the second index value.
